(19) United States
(12) Patent Application Publication
(10) Pub. No.: US 2009/0104525 A1
(43) Pub. Date: Apr. 23, 2009

(54) Secondary battery and manufacturing method thereof

(75) Inventors: Yugo Nakagawa, Toyohashi-shi (JP); Kenichi Suzuki, Toyohashi-shi (JP)

Correspondence Address: OLIFF & BERRIDGE, PLC, P.O. BOX 320850, ALEXANDRIA, VA, 22320-4850, US

(73) Assignee: PANASONIC EV ENERGY CO., LTD., KOSAI-SHI (JP)

(21) Appl. No.: 12/285,790

(22) Filed: Oct. 14, 2008

(30) Foreign Application Priority Data
Oct. 19, 2007 (JP) 2007-272188

(51) Int. Cl. H01M 6/00; H01M 4/00; B23K 15/00

(52) U.S. Cl. 429/209; 29/623.1; 219/121.14

(57) ABSTRACT

In a secondary battery, a positive metal foil having a laminated portion in which parts of the metal foil are laminated in close contact with each other, and a positive electrode current collector terminal member has a contact portion placed in close contact with at least one side of the positive foil laminated portion in a lamination direction thereof The secondary battery is manufactured by welding the parts of the positive metal foil to each other and the positive foil laminated portion and the contact portion to each other by irradiation of an energy beam emitted to travel in the lamination direction while an irradiation site is moved.

### CROSS-REFERENCE TO RELATED APPLICATIONS

This application is based upon and claims the benefit of priority from each of the prior Japanese Patent Application No. 2007-272188 on Oct. 19, 2007, the entire contents of which are incorporated herein by reference.

### BACKGROUND OF THE INVENTION

1. Field of the Invention

The present invention relates to a secondary battery in which a current collector and an electrode foil are connected by an energy beam and a manufacturing method of the secondary battery.

2. Description of Related Art

Regarding secondary batteries, heretofore, a connection technique by welding such as resistance welding has been employed to connect metal foils forming a positive electrode plate and a negative electrode plate to current collectors for taking out electric charges. However, a large battery to be mounted in a hybrid electric vehicle or the like needs large metal foils and large current collectors. The conventional connection technique by resistance welding therefore could only provide a relatively small welded area and large connection resistance. This would cause a problem that battery internal resistance increases due to the large connection resistance. Additionally, when such battery charges and discharges a large amount of current, a welded portion may locally heat. The resistance welding technique produces a welded portion in one place and accordingly breakage (separation) of the welded portion is likely to cause the loss of functionality. Therefore, the resistance welding technique cannot enhance connection reliability.

An ultrasonic welding technique is conceivable as another welding technique. However, ultrasonic vibration may cause separation of active materials and generation of powder dust.

Instead of the above techniques, a connection technique allowing connection with a wider welding area than the resistance welding has been proposed (see JP9(1997)-82305A). Specifically, JP '305A has proposed a secondary battery in which lead parts (metal foils) of a plurality of current collectors (positive electrode plates or negative electrode plates) are placed one on another and then the laminated lead parts are placed between electrode lead parts (current collectors), and those collector lead parts and electrode lead parts are welded to each other by an electron beam.

### BRIEF SUMMARY OF THE INVENTION

In JP '305A, however, the electron beam is emitted in a direction perpendicular to a lamination direction of the laminated collector lead parts and electrode lead parts to irradiate the side faces (end faces) of the lead parts and the electrode lead parts. Thus, portions near the end faces of the lead parts and the electrode lead parts are welded to each other. However, the electron beam is hard to reach deeper than the end faces of the lead parts. For instance, if energy of an electron beam is increased in order to melt the laminated lead parts from the end faces thereof to deeper portions to increase the area of a welded region (hereinafter, “a welded area”), the portions near the end faces of the lead parts so rise in temperature as to sublimate (evaporate), causing a blowhole, or a missing portion. The welded area is therefore restricted to the length of the end portions of the lead parts to be welded or the like. The technique disclosed in JP '305A has a limit in increasing the welded area between the lead parts and the electrode lead parts. In such secondary battery, consequently, the connection resistance occurring in the connected portion of the lead parts and the electrode lead parts could not be reduced sufficiently. As mentioned above, it has been difficult to provide the welded area of an appropriate size.

The present invention has been made in view of the above circumstances and has an object to provide a secondary battery in which metal foils and current collectors are welded by an energy beam with a welded area of an appropriately selected size.

Another object of the present invention is providing a manufacturing method of the above secondary battery.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided A secondary battery comprising:
a power generating element having a positive electrode plate including a positive metal foil and a negative electrode plate including a negative metal foil; and
at least one of a positive electrode collector terminal member welded to the positive metal foil and a negative electrode collector terminal member welded to the negative metal foil,
wherein one of the positive metal foil and the negative metal foil includes a foil laminated portion in which the metal foils are laminated in close contact with each other or a foil laminated portion in which one part and another part of the metal foil are laminated in close contact with each other,
one of the positive electrode collector terminal member and the negative electrode collector terminal member includes a contact portion placed on at least one side of the foil laminated portion in a lamination direction thereof and in close contact with the foil laminated portion,
one of a welded region between the positive metal foil and the positive electrode collector terminal member and a welded region between the negative metal foil and the negative electrode collector terminal member is formed in such a way that the metal foils or the parts of the metal foil in the foil laminated portion are irradiated and welded to each other and the foil laminated portion and the contact portion are irradiated and welded to each other by an energy beam emitted to travel in the lamination direction from a contact portion side toward a foil laminated portion side while an irradiation site is moved.

In the secondary battery of the invention, the metal foil includes the foil laminated portion in which the metal foils or one part and another part of the metal foil are laminated in close contact with each other. On the other hand, the collector terminal member includes the contact portion placed on at least one side of the foil laminated portion in the lamination direction thereof and in close contact with the foil laminated portion. The metal foils or the parts of the metal foil in the foil laminated portion, and the foil laminated portion and the contact portion are welded by the energy beam emitted to travel in the lamination direction from the contact portion side toward the foil laminated portion side while the irradiation site is moved.

In the secondary battery of the invention, unlike the related art, the welded region is not limited to the portion near the end portions of the metal foil(s). Thus, the position and the area of the welded region can be selected with high degree of freedom.

Accordingly, the metal foils or the parts of the metal foil in the foil laminated portion are reliably welded to each other while the foil laminated portion and the contact portion are welded in a wider area. The secondary battery can therefore be made with the welded area of the appropriately selected size between the metal foil(s) and the collector terminal member.

This also makes it possible to provide the secondary battery in which the positive metal foil(s) and the positive electrode collector terminal member or the negative metal foil(s) and the negative electrode collector terminal member are welded in the welded area of an appropriate size, resulting in a reduced connection resistance therebetween.

The energy beam has a high energy density and can heat a narrow region to a high temperature. Accordingly, when the energy beam is directly irradiated to each of the metal foils or each part of the metal foil individually in its thickness direction, the energy will concentrate on a region corresponding to one sheet of each thin metal foil. Consequently, in this region the metal foil will sublimate (evaporate), rather than melt, forming through holes in succession as to disturb welding.

On the other hand, for the secondary battery of the invention, the energy beam which travels from the contact portion side to the foil laminated portion side is used. Specifically, the energy beam is emitted to impinge on the collector terminal member earlier than the foil laminated portion (the metal foil), thereby melting the collector terminal member earlier and causing the collector terminal member to absorb and disperse the energy of the energy beam. In this state, subsequently, this energy beam is indirectly irradiated to the foil laminated portion (the metal foil) in its thickness direction (the lamination direction). This makes it possible to provide the secondary battery in which the foil laminated portion and the contact portion are welded to each other with less defects such as a missing part caused by sublimation (evaporation) of the metal foil in the foil laminated portion.

Furthermore, the energy beam is irradiated while the irradiation site is moved. It is therefore possible to reduce the disadvantages that the energy of the energy beam concentrates on one place, excessively heating the metal foil and the contact portion therein, resulting in sublimation or a blowhole causing a missing part.

The secondary battery may includes any secondary batteries capable of repeatedly charging and discharging, such as a lithium ion secondary battery, a nickel-metal hydride secondary battery, and a nickel-cadmium secondary battery.

The power generating element may be provided with a separator between the positive electrode plate and the negative electrode plate, in addition to the positive electrode plate and the negative electrode plate. Accordingly, the power generating element may include a lamination-type power generating element in which a plurality of positive electrode plates and a plurality of negative electrode plates are laminated alternately with separators being interposed therebetween, and a winding-type power generating element in which a band-shaped positive electrode plate and a band-shaped negative electrode plate are wound with a band-shaped separator being located therebetween.

The positive electrode plate may include the positive metal foil and a positive active material layer carried on the positive metal foil. Similarly, the negative electrode plate may include the negative metal foil and a negative active material layer carried on the negative metal foil.

In the case where the lamination-type power generating element is used as the power generating element as mentioned above, for example, the plurality of positive metal foils or the plurality of negative metal foils are laminated so that one sides thereof are in close contact with each other, thereby forming the foil laminated portion. In the case where the winding-type power generating element is used as the power generating element as mentioned above, for example, one part and another part of the band-shaped positive metal foil or the band-shaped negative metal foil are laminated in close contact with each other, thereby forming the foil laminated portion.

Furthermore, the collector terminal member has the contact portion placed on at least one side of the foil laminated portion in the lamination direction and in close contact therewith. Accordingly, for example, this collector terminal member may include a collector terminal member configured to have a contact portion that closely contacts with only one side of the foil laminated portion in the lamination direction thereof, a collector terminal member constituted of two components each having a contact portion that closely contacts with one side or the other side of the foil laminated portion in the lamination direction thereof, and a collector terminal member configured to have two contact portions that closely contact both sides of the foil laminated portion in the lamination direction, for example, configured to have the contact portions whose ends are joined to each other into an angular U-shape or a U-shape.

In order to make the metal foils or the parts of the foil in the foil laminated portion contact with each other by tightly holding them and to facilitate close contact between the foil laminated portion and the contact portions, the collector terminal member is more preferably configured that the contact portions are placed on both sides of the foil laminated portion in the lamination direction thereof to tightly hold foil laminated portion between the contact portions.

The energy beam may include an electron beam and a laser beam, for example.

For movement of the energy beam, the energy beam and the power generating element have only to be relatively moved. For instance, a workpiece (the power generating element and the collector terminal member) placed on an XY table or the like is moved, an emission source (an electron gun, a laser source, etc.) for the energy beam is moved, or the energy beam is deflected. An irradiation pattern of the energy beam may include an irradiation pattern that causes the energy beam to repeatedly scan back and forth in one of the directions (along a plane of the metal foil in the foil laminated portion) perpendicular to a traveling direction of the energy beam while gradually displacing the energy beam in a direction perpendicular to the one way direction, and an irradiation pattern in which the energy beam is appropriately moved in two directions orthogonal to the emission direction and perpendicular to each other to irradiate a circular region, a rectangular region, and so on.

In the aforementioned secondary battery, preferably, the welded region is formed by irradiation of an electron beam used as the energy beam.

The secondary battery of the invention includes the welded region made by irradiation of the electron beam. This welding using the electron beam is performed under vacuum, so that components in air are unlikely to enter the welded region and oxidation less occurs. Therefore, the secondary battery can have the welded region resistant to oxidation and with high quality.

The electron beam has to be used for welding under vacuum as mentioned above. If water or moisture adheres to each component or member, it will evaporate, thereby disturbing an increase in vacuum level. The secondary battery of the invention is preferably a nonaqueous electrolyte, lithium ion secondary battery which is produced by removing water or moisture.

In the aforementioned secondary battery, furthermore, it is preferable that the collector terminal member includes the contact portions placed on both sides of the foil laminated portion in the lamination direction.

This secondary battery is manufactured by use of the energy beam directed to travel in the lamination direction of the foil laminated portion, from the contact portion side toward the foil laminated portion side. Accordingly, the energy beam is irradiated to the contact portion and indirectly to the foil laminated portion (the metal foil(s)) through the contact portion. The metal foil(s) is welded to the melted contact portion without sublimation (evaporation).

However, the energy beam has a property that its energy reaches a deep portion of a target to be irradiated. Accordingly, in the case where the contact portion of the collector terminal member is placed on only one side of the foil laminated portion (i.e. at the rear side in the traveling direction of the electron beam), that is, in the case where no contact portion exists at the leading side in the traveling direction of the electron beam relative to the foil laminated portion, the energy of the energy beam is apt to concentrate on each metal foil or each part of the metal foil in the foil laminated portion located at the leading side in the energy beam traveling direction. This irradiated portion may rise in temperature to sublimate, thereby causing a through hole, or a missing part.

In the secondary battery of the invention, on the other hand, the collector terminal member has the contact portions on both sides of the foil laminated portion in the lamination direction thereof. Thus, one of the two contact portions, which is located at the leading side in the energy beam traveling direction relative to the foil laminated portion, will also receive the energy of the energy beam. As mentioned above, this makes it possible to prevent concentration of the energy of the energy beam on each metal foil or each part of the metal foil in the foil laminated portion, which is located at the leading side in the energy beam traveling direction. Consequently, the secondary battery can be provided with the foil laminated portion (the metal foil) and the collector terminal member reliably welded to each other with less defects such as a missing part in the metal foil or metal foil part caused by sublimation (evaporation) of the metal foil.

According to another aspect, the invention provides a manufacturing method of a secondary battery comprising a power generating element having a positive electrode plate including a positive metal foil and a negative electrode plate including a negative metal foil; and at least one of a positive electrode collector terminal member welded to the positive metal foil and a negative electrode collector terminal member welded to the negative metal foil, the method comprising: a contacting step in which a contact portion of one of the positive electrode collector terminal member and the negative electrode collector terminal member is placed in close contact with at least one side of the foil laminated portion in a lamination direction thereof, the foil laminated portion including one of the positive metal foils and the negative metal foils or one of parts of the positive metal foil and parts of the negative metal foil, which are laminated in close contact with each other, and a welding step in which an energy beam is emitted to travel in the lamination direction from a contact portion side to a foil laminated portion side to irradiate the contact portion and the foil laminated portion while an irradiation site is moved, to weld the metal foils or the parts of the metal foil in the foil laminated portion to each other and weld the foil laminated portion to the contact portion.

The manufacturing method of the invention includes the contacting step and the welding step. In the contacting step, firstly, the contact portion is placed in close contact with at least one side of the foil laminated portion in the lamination direction thereof. In the welding step, subsequently, the metal foils or the parts of the metal foil in this foil laminated portion, and the foil laminated portion and the contact portion, are welded to each other by the energy beam that travels in the lamination direction of the foil laminated portion from the contact portion side toward the foil laminated portion side while the irradiation site is moved. Unlike the aforementioned related art, the welded region is not restricted by the length of the end(s) of the metal foil(s) and also not limited to the portion near the end(s) of the metal foil(s). Accordingly, the position and the area of the welded region can be selected with high degree of freedom. The metal foils or parts of the metal foil in the foil laminated portion are reliably welded to each other and also the foil laminated portion and the contact portion are welded to each other in a wide area. The secondary battery can therefore be manufactured with the area of the welded region of an appropriately selected size between the metal foil and the collector terminal member. The positive metal foil(s) and the positive electrode collector terminal member or the negative metal foil(s) and the negative electrode collector terminal member are welded in a welded area of an appropriately size. Thus, the secondary battery with reduced connection resistance between the metal foil(s) and the collector terminal member can be produced.

By use of the energy beam which is emitted to travel from the contact portion side toward the laminated portion side, the secondary battery can be manufactured by allowing the collector terminal member to absorb and disperse the energy of the energy beam, thereby reducing defects such as a missing part caused by sublimation (evaporation) of the metal foil(s) in the foil laminated portion.

As explained above, the energy beam has a high energy density capable of heating a narrow region to a high temperature. Accordingly, if the energy beam is directly emitted toward each metal foil or each foil part in its thickness direction, the energy will concentrate on a region corresponding to each sheet of the thin metal foil, thereby sublimating (evaporating) the metal foil, rather than melting it. This causes many through holes in succession, resulting in difficulty in welding.

The manufacturing method of the secondary battery of the invention comprises welding by use of the energy beam emitted to travel from the contact portion side toward the foil laminated portion side. Specifically, the energy beam is emitted to impinge on the collector terminal member earlier than the foil laminated portion (the metal foil), thereby melting the collector terminal member earlier and causing the collector terminal member to absorb and disperse the energy of the energy beam. In this state, subsequently, this energy beam is indirectly irradiated toward the foil laminated portion (the metal foil) in its thickness direction (the lamination direction). In addition, the metal foils or the parts of the metal foil in the foil laminated portion closely contact each other. This makes it possible to produce the secondary battery in which the foil laminated portion and the contact portion are welded to each other with less defects such as a missing part caused by sublimation (evaporation) of the metal foil in the foil laminated portion.

Furthermore, the energy beam is irradiated while the irradiation site is moved. It is therefore possible to reduce the disadvantages that the energy of the energy beam concentrates on one place, excessively heating the metal foil(s) and the collector terminal member, resulting in sublimation or a blowhole causing a missing part.

In the contacting step where the foil laminated portion is placed in close contact with the contact portion, the metal foils constituting the foil laminated portion or one part and another part of the metal foil have only to be in close contact with each other. For example, it may be arranged to place the foil laminated portion and the contact portion in close contact relation and simultaneously place the metal foils or a part or another part of the metal foil forming the foil laminated portion in close contact relation. Prior to the contacting step, the metal foils or a part or another part of the metal foil may previously be placed in close contact relation to form the foil laminated portion.

The contact step of placing the foil laminated portion and the contact portion may include for example a contacting technique using a separate member or tool such as a vise and a press, a contacting technique by ultrasonic welding or resistance welding to temporarily weld parts of the foil laminated portion and the contact portion, and a contacting technique of placing the foil laminated portion and the contact portion in close contact relation by deforming, by crimping or the like, the collector terminal member itself having two contact portions between which the foil laminated portion is held, thereby holding the foil laminated portion and the contact portion in close contact relation.

In the manufacturing method of the secondary battery, preferably, the beam is an electron beam.

In the manufacturing method of the secondary battery of the invention, the welding step includes welding by irradiation of the electron beam. Accordingly, components in air are unlikely to enter the welded region and oxidation less occurs. Therefore, the secondary battery can be manufactured in which the welded region is resistant to oxidation and with high quality.

In the aforementioned manufacturing method of the secondary battery, furthermore, it is preferable that the contacting step includes placing the foil laminated portion and the contact portion in close contact relation and laminating the metal foils or one part and another part of the metal foil of the power generating element into close contact relation to form the foil laminated portion.

According to the manufacturing method of the secondary battery of the invention, in the contacting step, the metal foils or one part and another part of the metal foil are placed in close contact with each other to form the foil laminated portion and simultaneously this foil laminated portion and the contact portion are placed in close contact with each other. Thus, the metal foils or one part and another part of the metal foil do not have to be brought into close contact with each other in advance. The secondary battery can be manufactured more easily.

Alternatively, the aforementioned manufacturing method of the secondary battery may further comprise a foil contacting step in which the metal foils or one part and another part of the metal foil of the power generating element are laminated in close contact with each other to form the foil laminated portion, the foil contacting step being performed prior to the contacting step.

The manufacturing method of the secondary battery of the invention includes a foil contacting step prior to the contacting step. In other words, in the foil contacting step performed earlier than the contacting step, the metal foils or one part and another part of the metal foil are placed into contact with each other to form the foil laminated portion. Accordingly, after the foil laminated portion is completely made, the subsequent contacting step is started.

For example, the foil contacting step may include a step of placing the metal foils or the parts of the foil in close contact with each other at one or more places by use of ultrasonic welding or resistance welding to form the foil laminated portion, and a step of placing the metal foils or the parts of the foil in close contact with each other by mechanically folding them.

In the aforementioned secondary battery, preferably, the contacting step includes placing the contact portion of the collector terminal member in close contact with both sides of the foil laminated portion in the lamination direction.

As mentioned above, the energy beam for irradiating the secondary battery is emitted to travel in the lamination direction of the foil laminated portion from the contact portion side toward the foil laminated portion side. The energy beam is therefore irradiated to the contact portion and indirectly to the foil laminated portion (the metal foils or the parts of the metal foil) through the contact portion. This makes it possible to weld the metal foils or the parts of the metal foil to the melted contact portion without sublimating (evaporating).

Herein, it is considered the case where the contact portion of the collector terminal member is placed on only one side of the foil laminated portion (at the rear side in the energy beam traveling direction), that is, the case where no contact portion exists at the leading side of the foil laminated portion in the beam traveling direction. In this case, the energy beam is indirectly irradiated to the metal foils or the parts of the metal foil in the foil laminated portion, but the energy of the energy beam is apt to concentrate on each metal foil or each metal foil part, which will sublimate, forming many through holes in the metal foils or the parts of the metal foil, thereby disturbing good welding.

In the manufacturing method of the secondary battery of the invention, on the other hand, the collector terminal member is placed in close contact with both sides of the foil laminated portion in the lamination direction. In the welding step, accordingly, even one of the two contact portions, which is located at the leading side in the energy beam traveling direction relative to the foil laminated portion, will also receive the energy of the energy beam. As mentioned above, this makes it possible to prevent concentration of the energy of the energy beam on each metal foil or each metal foil part in the foil laminated portion, which is located at the leading side in the energy beam traveling direction. Consequently, the secondary battery can be manufactured in which the foil laminated portion (the metal foil) and the collector terminal member are reliably welded to each other with less defects such as a missing part in the metal foil caused by sublimation (evaporation) of the metal foil.

In the aforementioned manufacturing method of the secondary battery, further preferably, the collector terminal member includes: a first contact portion placed on one side of the foil laminated portion in the lamination direction; and a second contact portion placed on the other side in the lamination direction.

In the manufacturing method of the secondary battery of the invention, the collector terminal member having the first and second contact portions is used. With use of this collector terminal member, the foil laminated portion is sandwiched between and in contact with the first and second contact portions of a single component placed on both sides of in the lamination direction. This enables a configuration that the foil laminated portion is tightly held between two contact portions and hence the secondary battery can be manufactured more easily.

It is preferable to deform the collector terminal member itself by crimping or the like to thereby tightly hold the foil laminated portion in close contact with and between the first and second contact portions of the collector terminal member.

Accordingly, the foil laminated portion can be kept in close contact relation to the first and second contact portions without a special member or tool after the crimping or the like, thereby allowing them to be easily handled in subsequent steps such as the welding step.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1A is an explanatory view of a secondary battery in a first embodiment, including a sectional view of a battery case;

FIG. 1B is a sectional view of the secondary battery taken along a line A-A in FIG. 1A;

FIG. 2A is an explanatory view of the secondary battery in the first embodiment and a third embodiment, corresponding to a cross sectional view of the secondary battery taken along a line B-B (G-G) in FIG. 1A (10A);

FIG. 2B is an enlarged view of a part C in FIG. 2A;

FIGS. 3A to 3C are explanatory views showing a contacting step of a manufacturing method of the secondary battery in the first embodiment;

FIGS. 4A and 4B are explanatory views showing a welding step of the manufacturing method of the secondary battery in the first embodiment;

FIGS. 5A to 5C are explanatory views showing a foil contacting step of a manufacturing method of the secondary battery in a modified example;

FIG. 6A is an explanatory view of a secondary battery in a second embodiment, including a sectional view of a battery case;

FIG. 6B is a sectional view of the secondary battery taken along a line D-D in FIG. 6A;

FIG. 7 is a cross sectional view of the secondary battery in the second embodiment, taken along a line E-E in FIG. 6A;

FIGS. 8A to 8C are explanatory views showing a contacting step of a manufacturing method of the secondary battery in the second embodiment;

FIGS. 9A and 9B are explanatory views showing a welding step of the manufacturing method of the secondary battery in the second embodiment;

FIG. 10A is an explanatory view of a secondary battery in a third embodiment, including a sectional view of a battery case;

FIG. 10B is a sectional view of the secondary battery taken along a line F-F in FIG. 10A;

FIGS. 11A to 11C are explanatory views showing a contacting step of a manufacturing method of the secondary battery in the third embodiment; and

FIGS. 12A and 12B are explanatory views showing a welding step of the manufacturing method of the secondary battery in the third embodiment;

### DETAILED DESCRIPTION OF THE PREFERRED EMBODIMENTS

### First Embodiment

A detailed description of a first preferred embodiment of the present invention will now be given referring to the accompanying drawings.

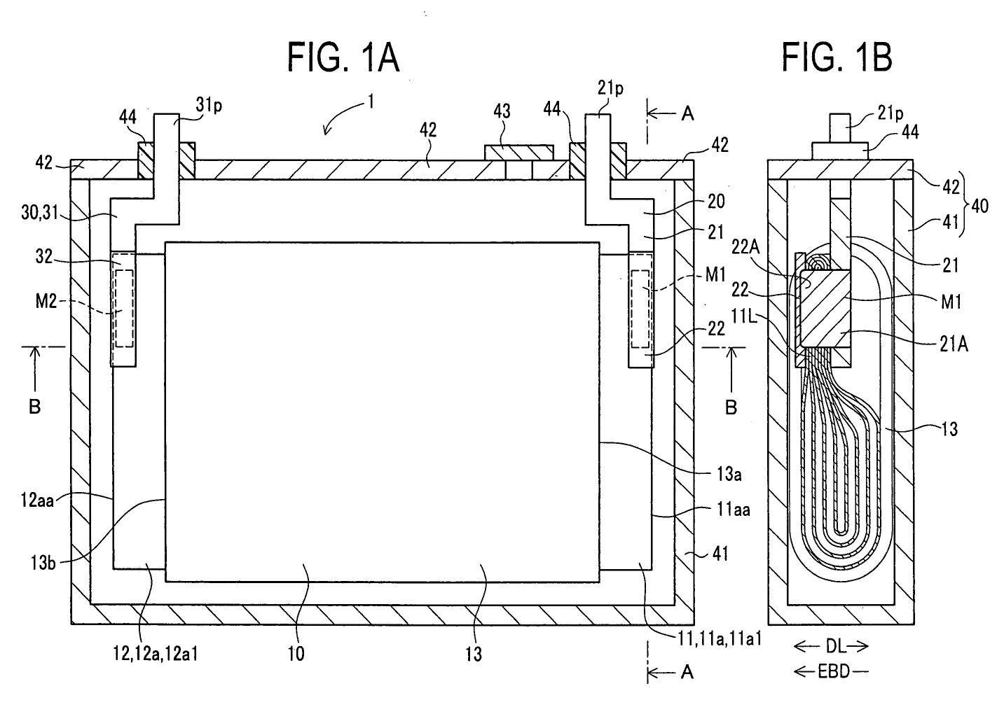

A secondary battery 1 in the first embodiment is a lithium ion secondary battery including a power generation element 10, a positive electrode collector terminal member (hereinafter, a “positive collector member”) 20, a negative electrode collector terminal member (hereinafter, a “negative collector member”) 30, and a battery case 40 as shown in FIG. 1A.

The battery case 40 includes a case body 41, a cover 42, a safety valve 43, and insulating parts 44.

The case body 41 is a metal, bottom-closed rectangular container having an upper opening. The cover 42 on which the safety valve 43 is provided is placed to close the upper opening of the case body 41. The case body 41 and the cover 42 liquid-tightly enclose the power generating element 10, the positive collector member 20, the negative collector member 30, and electrolyte not shown.

The positive collector member 20 is constituted of two parts; a positive electrode collector terminal main part (hereinafter, “positive collector main part” or “main part”) 21 and a positive electrode collector terminal auxiliary part (hereinafter, “positive collector auxiliary part” or “auxiliary part”) 22. The main part 21 is made of a plate bent in crank form and the auxiliary part 22 is made of a rectangular plate. The main part 21 has a positive terminal 21p at one end, which passes through the cover 42 to protrude therefrom. One insulating part 44 is interposed between this positive terminal 21p and the cover 42 to insulate them from each other.

The negative collector member 30 is constituted of two parts; a negative electrode collector terminal main part (hereinafter, “negative collector main part” or “main part”) 31 and a negative electrode collector terminal auxiliary part (hereinafter, “negative collector auxiliary part” or “auxiliary part”) 32. The main part 31 is made of a plate bent in crank form and the auxiliary part 32 is made of a rectangular plate. The main part 31 has a negative terminal 31p at one end, which passes through the cover 42 to protrude therefrom. The other insulating part 44 is interposed between this negative terminal 31p and the cover 42 to insulate them from each other.

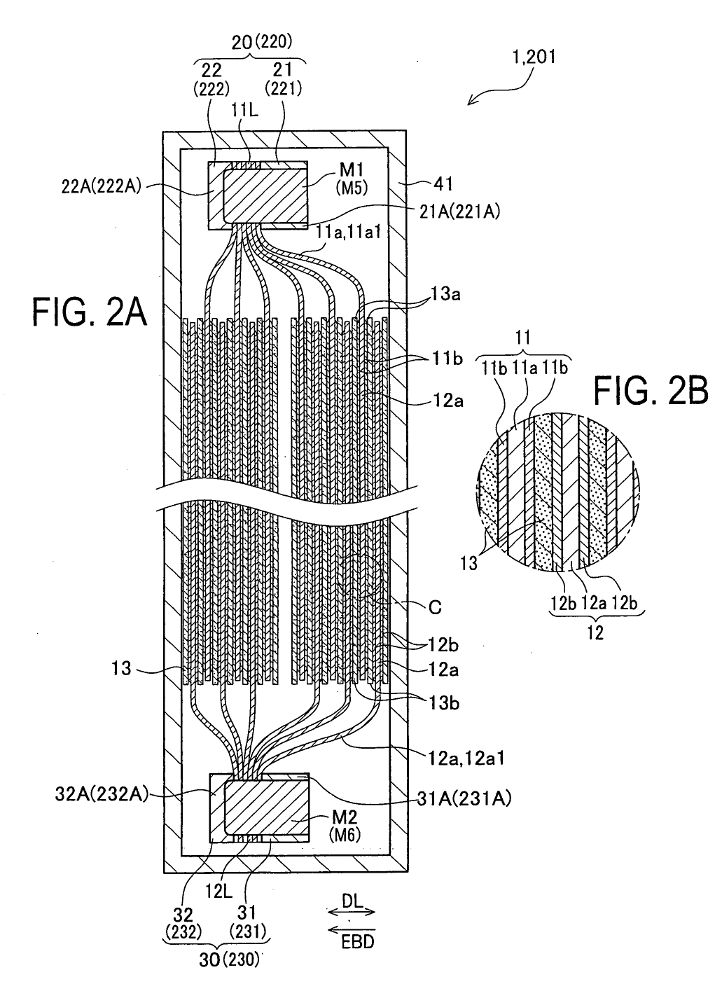

The power generating element 10 includes a band-shaped positive electrode plate 11, a band-shaped negative electrode plate 12, and a band-shaped separator 13. This power generating element 10 is a winding-type power generating element in which the band-shaped positive electrode plate 11 in which positive active material layers 11b are carried on both surfaces of a band-shaped positive metal foil 11a and the band-shaped negative electrode plate 12 in which negative active material layers 12b are carried on both surfaces of a band-shaped negative metal foil 12a are wound with the band-shaped separator 13 being interposed therebetween. This power generating element 10 has a lamination structure as seen in FIG. 2B.

The positive metal foil 11a includes a long side portion 11a1 along a long side 11aa of two long sides extending in a longitudinal direction of the band-shaped metal foil 11a. The long side portion 11a1 does not carry thereon the positive active material 11b and extends outward (rightward in FIG. 1A) from a first end face 13a of the separator 13. This long side portion 11a1 is configured so that a part of the metal foil 11a (the long side portion 11a1) is laminated on another part when the metal foil 11a is wound. A part of the extending long side portion 11a1 of the positive metal foil 11a is sandwiched between a contact portion 21A of the positive collector main part 21 and the positive collector auxiliary part 22 made in rectangular form of the same metal as the main part 21 so that one part and another part of the metal foil 11a are laminated in close contact relation to form a positive foil laminated portion 11L. Furthermore, a part of the positive foil laminated portion 11L, a part of the main part 21, and a part of the auxiliary part 22 are welded to each other by an electron beam mentioned later to form a positive-side welded region M1 for positive electrode (see FIG. 2A).

On the other hand, other portions of the long side portion 11a1 of the positive metal foil 11a extending from the separator 13, excepting the positive foil laminated portion 11L including the positive-side welded region M1, are arranged with clearances between each other in noncontact relation. Accordingly, the electrolyte not shown is allowed to be distributed through the clearances to every portion of the positive active material layers 11b, the negative active material layers 12b, and the separator 13 in the power generating element 10. Gas generated inside the power generating element 10 during charge and discharge of the secondary battery 1 will be released out of the power generating element 10 through the clearances, but within the battery case 40.

The contact portion 21A of the positive collector main part 21 and a contact portion 22A of the positive collector auxiliary part 22 are located to face each other on both sides of the foil laminated portion 11L when viewed in a lamination direction DL of the long side portion 11a1 of the positive metal foil 11a so that the contact portions 21A and 22A are placed in close contact with the foil laminated portion 11L.

The band-shaped negative metal foil 12a is configured as with the above positive metal foil 11a. Specifically, the negative metal foil 12a includes a long side portion 12a1 along a long side 12aa of two long sides extending in a longitudinal direction of the band-shaped metal foil 12a. The long side portion 12a1 does not carry thereon the negative active material 12b and extends outward (leftward in FIG. 1A) from a second end face 13b of the separator 13. This long side portion 12a1 is configured so that a part of the metal foil 12a (the long side portion 12a1) is laminated on another part when the metal foil 12a is wound. A part of the extending long side portion 12a1 of the negative metal foil 12a is sandwiched between a contact portion 31A of the negative collector main part 31 and a negative collector auxiliary part 32 made in rectangular form of the same metal as the main part 31 so that one part and another part of the metal foil 12a are laminated in close contact relation to form a negative foil laminated portion 12L. Furthermore, a part of the negative foil laminated portion 12L, a part of the main part 31, and a part of the auxiliary part 32 are welded to each other by an electron beam mentioned later to form a negative-side welded region M2 for negative electrode (see FIG. 2A).

On the other hand, other portions of the long side portion 12a1 of the negative metal foil 12a extending from the separator 13, excepting the negative foil laminated portion 12L including the negative-side welded region M2, are arranged with clearances between each other in noncontact relation. Accordingly, the electrolyte not shown is allowed to be distributed through the clearances to every portion of the positive active material layers 11b, the negative active material layers 12b, and the separator 13.

The contact portion 31A of the negative collector main part 31 and the contact portion 32A of the negative collector auxiliary part 32 are located to face each other on both sides of the foil laminated portion 12L when viewed in the lamination direction DL of the long side portion 12al of the negative metal foil 12a so that the contact portions 31A and 32A are placed in close contact with the foil laminated portion 12L.

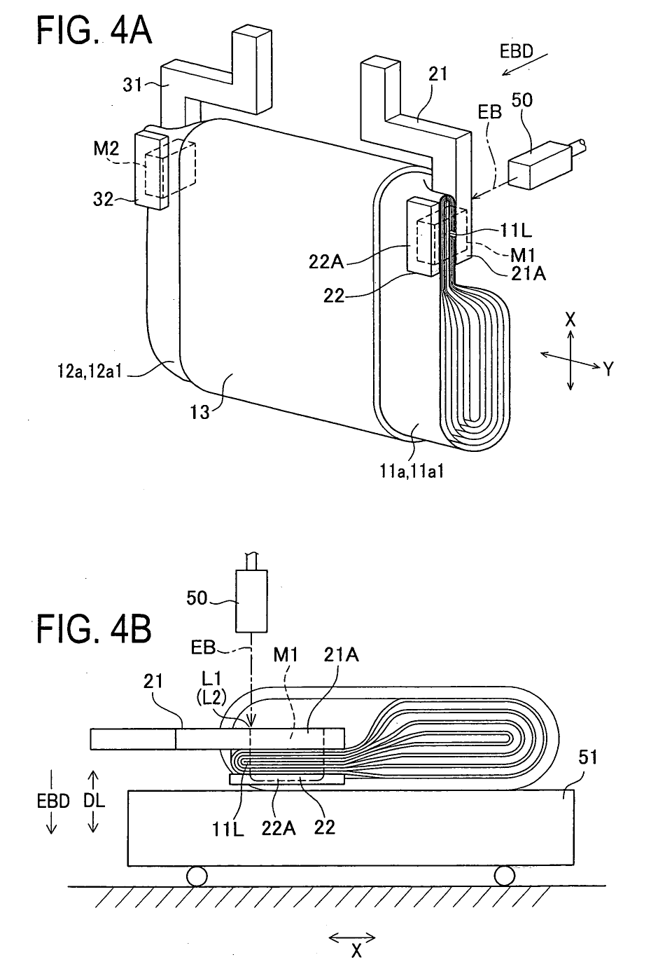

In the secondary battery 1 in the first embodiment, as mentioned above, a part of the long side portion 11a1 is laminated on another part thereof in close contact relation to form the positive foil laminated portion 11L. On the other hand, the contact portion 21A of the positive collector main part 21 is located on one side (a right side in FIG. 2A) of the foil laminated portion 11L in the lamination direction DL and in close contact with the foil laminated portion 11L. The positive collector auxiliary part 22 is located on the other side (a left side in FIG. 2A) of the foil laminated portion 11L in the lamination direction DL and entirely in close contact with the foil laminated portion 11L, providing the auxiliary contact portion 22A. Those three portions; positive foil laminated portion 11L, contact portion 21A, and auxiliary contact portion 22A are welded in the positive-side welded region M1 by the electron beam EB traveling in the lamination direction DL from a contact portion 21A side toward a positive foil laminated portion 11L side (see FIG. 4A).

The electron beam EB is irradiated while a positive-side irradiation site L1 is moved (i.e., the position of the irradiation site L1 is changed). Concretely, an XY table 51 (see FIGS. 4A and 4B) on which the power generating element 10 and others are set is moved in an X direction and a Y direction to move the irradiation site L1 during irradiation of the electron beam EB. Thus, the position and the area of a welded region between the positive foil laminated portion 11L and the contact portion 21A and the position and the area of a welded region between the positive foil laminated portion 11L and the auxiliary contact portion 22A can be selected with high degree of freedom. This makes it possible to produce the welded area of an appropriate size, thereby reducing connection resistance between the positive collector main part 21 and the positive metal foil 11a.

In the secondary battery 1 in the first embodiment, the positive-side welded region M1 is made by irradiation of the electron beam EB. Accordingly, components in air are unlikely to enter the region M1 and oxidation less occurs. The secondary battery 1 can therefore have the positive-side welded region M1 resistant to oxidation and with high quality.

In the secondary battery 1 in the first embodiment, the negative electrode side is configured as in the positive electrode side; specifically, a part of the long side portion 12a1 of the negative metal foil 12a is laminated on another part thereof in close contact relation to form the negative foil laminated portion 12L. On the other hand, the contact portion 31A of the negative collector main part 31 is located on one side (a right side in FIG. 2A) of the foil laminated portion 12L in the lamination direction DL and in close contact with the foil laminated portion 12L. The negative collector auxiliary part 32 is located on the other side (a left side in FIG. 2A) of the foil laminated portion 12L in the lamination direction DL and entirely in close contact with the foil laminated portion 12L, providing the auxiliary contact portion 32A. Those tree portions; negative foil laminated portion 12L, contact portion 31A, and auxiliary contact portion 32A are welded in the negative-side welded region M2 by the electron beam EB traveling in the lamination direction DL from a contact portion 31A side toward a negative foil laminated portion 12L side (see FIG. 4A).

The electron beam EB is irradiated while a negative-side irradiation site L2 is moved. Concretely, the XY table 51 (see FIGS. 4A and 4B) on which the power generating element 10 and others are set is moved in the X direction and the Y direction to move the irradiation site L2 during irradiation of the electron beam EB. Thus, the position and the area of a welded region between the negative foil laminated portion 12L and the contact portion 31A and the position and the area of a welded region between the negative foil laminated portion 12L and the auxiliary contact portion 32A can be selected with high degree of freedom. This makes it possible to produce the welded area of an appropriate size, thereby reducing connection resistance between the negative collector auxiliary part 22 and the negative metal foil 12a.

In the secondary battery 1 in the first embodiment, the negative-side welded region M2 is made by irradiation of the electron beam EB. Accordingly, components in air are unlikely to enter the region M2 and oxidation less occurs. The secondary battery 1 can therefore have the negative-side welded region M2 resistant to oxidation and with high quality.

In the secondary battery 1 in the first embodiment, the contact portion 21A of the positive collector main part 21 is arranged on one side of the positive foil laminated portion 11L in the lamination direction DL and in close contact with the foil laminated portion 11L. In addition, the contact portion 22A of the positive collector auxiliary part 22 is placed on the other side of the foil laminated portion 11L opposite from the aforementioned contact portion 21A in the lamination direction DL and held in close contact with the foil laminated portion 11L. Similarly, the contact portion 31A of the negative collector main part 31 and the contact portion 32A of the negative collector auxiliary part 32 are placed on both sides of the negative foil laminated portion 12L in the lamination direction DL and held in close contact with the foil laminated portion 12L respectively.

Meanwhile, if the auxiliary contact portion 22A and the auxiliary contact portion 32A are not provided, the energy of the electron beam EB is apt to concentrate on parts of the metal foils 11a and 12a forming the foil laminated portions 11L and 12L respectively, the parts being located at a leading (or forward) side in an electron beam traveling direction EBD along the lamination direction DL. This portion may rise in temperature to sublimate, causing a missing part such as a through hole.

On the other hand, the secondary battery 1 in the first embodiment includes the collector auxiliary parts 22 and 32 of which the auxiliary contact portions 22A and 32A are placed in close contact with the positive foil laminated portion 11L and the negative foil laminated portion 12L respectively. Thus, the auxiliary contact portion 22A to the positive laminated portion 11L and the auxiliary contact portion 32A to the negative laminated portion 12L located on the leading side in the traveling direction EBD of the electron beam EB relative to the positive foil laminated portion 11L or the negative foil laminated portion 12L will also receive the energy of the electron beam EB. This makes it possible to prevent the energy of the electron beam from locally concentrating on parts of the metal foils 11a and 12a, thereby restraining defects such as missing portions in the metal foils 11a and 12a. In the secondary battery 1, consequently, the positive foil laminated portion 11L is reliably welded to the positive collector main part 21 and the positive collector auxiliary part 22 respectively and, similarly, the negative foil laminated portion 12L is reliably welded to the negative collector main part 31 and the negative collector auxiliary part 32 respectively.

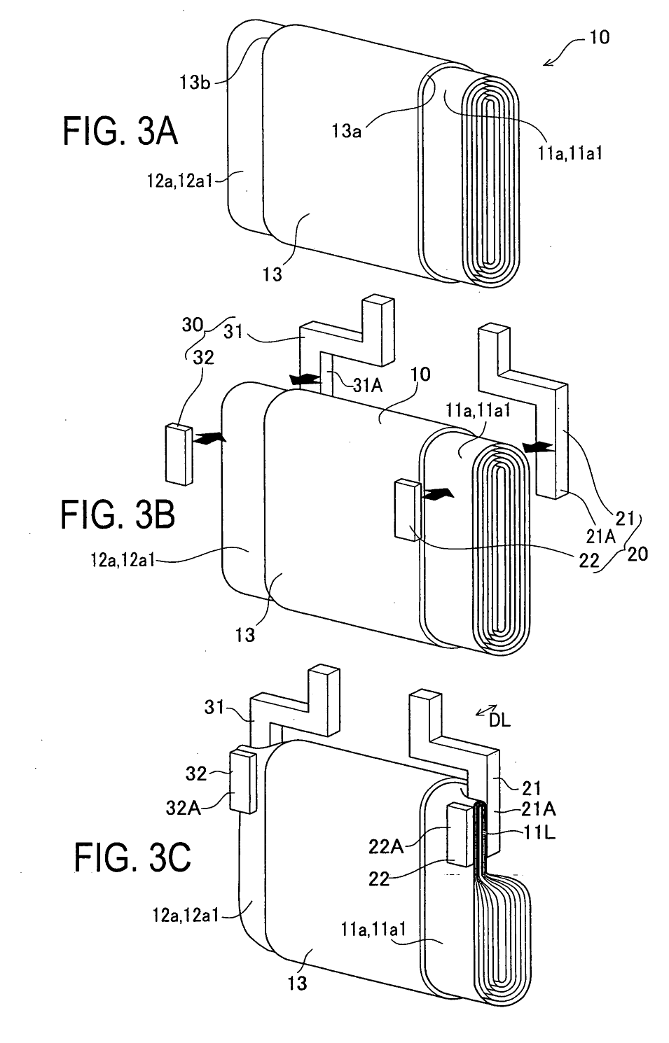

A manufacturing method of the secondary battery 1 in the first embodiment will be described below referring to FIGS. 3A to 3C and FIGS. 4A and 4B.

The power generating element 10 formed in a flat shape as shown in FIG. 3A is first produced in such a way that the band-shaped positive electrode plate 11 and the negative electrode plate 12 are wound with the separator 13 interposed therebetween. The long side portion 11a1 of the positive metal foil 11a extends from the first end face 13a which is one of two end faces extending in a longitudinal direction of the separator 13. On the other hand, the long side portion 12a1 of the negative metal foil 12a extends from the second end face 13b of the separator 13. In this state, one part and another part of the long side portion 11a1 of the positive metal foil 11a are arranged in layers but spaced with clearances to be in noncontact with adjacent parts. Similarly, one part and another part of the long side portion 12a1 of the negative metal foil 12a are arranged in noncontact relation.

In a contacting step, successively, parts of the long side portion 11a1 of the positive metal foil 11a at one place are sandwiched between the contact portion 21A of the positive collector main part 21 and the positive collector auxiliary part 22. Specifically, about half (an upper half in FIG. 3B) of the long side portion 11a1 of the positive metal foil 11a extending from the first end face 13a of the separator 13 is sandwiched between the positive collector main part 21 and the positive collector auxiliary part 22 by use of a clamping tool such as a vise not shown. Accordingly, one part and another part of the long side portion 11a1 of the positive metal foil 11a are put in close contact with each other to form the positive foil laminated portion 11L. Simultaneously, the laminated portion 11L is held in close contact with the positive collector main part 21 and the positive collector auxiliary part 22 respectively. Thus, the positive foil laminated portion 11L is in close contact with the contact portions 21A and 22A respectively on both sides in the lamination direction DL. In other words, the positive foil laminated portion 11L closely contacts with the contact portion 21A of the positive collector main part 21 on one side and with the contact portion 22A of the positive collector auxiliary part 22 on the other side (see FIG. 3C).

In the first embodiment, as mentioned in the contacting step, one part and another part of the long side portion 11a1 of the positive metal foil 11a are placed in close contact with each other to form the positive foil laminated portion 11L and also this laminated portion 11L is held in close contact with the contact portion 21A and the auxiliary contact portion 22A respectively. Accordingly, one part and another part of the long side portions 11a1 of the positive metal foil 11a do not have to be placed in advance in close contact with each other to form the positive foil laminated portion 11L. The secondary battery 1 can be manufactured more easily.

In a similar manner to the above, parts of the long side portion 12a of the negative metal foil 12a are sandwiched between the contact portion 31A of the negative collector main part 31 and the negative collector auxiliary part 32. Specifically, about half (an upper half in FIG. 3B) of the long side portion 12a1 of the negative metal foil 12a extending from the second end face 13b of the separator 13 is sandwiched between the negative collector main part 31 and the negative collector auxiliary part 32 by use of a clamping tool such a vise not shown. Accordingly, one part and another part of the negative metal foil 12a are put in close contact with each other to form the negative foil laminated portion 12L. Simultaneously, the laminated portion 12L is held in close contact with the negative collector main part 31 and the negative collector auxiliary part 32 respectively. Thus, the negative foil laminated portion 12L is in close contact with the contact portions 31A and 32A respectively on both sides in the lamination direction DL. In other words, the negative foil laminated portion 12L closely contacts with the contact portion 31A of the negative collector main part 31 on one side and with the contact portion 32A of the negative collector auxiliary part 32 respectively (see FIG. 3C).

In the first embodiment, in this contacting step, the negative foil laminated portion 12L is also formed on the negative electrode side and this laminated portion 12L is put in close contact with the contact portion 31A and the auxiliary contact portion 31A respectively. Accordingly, the negative foil laminated portion 12L does not have to be formed in advance. The secondary battery 1 can be manufactured more easily.

A welding step will be explained below referring to FIGS. 4A and 4B. In the first embodiment, the contact portion 21A, the positive foil laminated portion 11L, and the auxiliary contact portion 22A are welded to each other by the electron beam EB. Similarly, the contact portion 31A, the negative foil laminated portion 12L, and the auxiliary contact portion 32A are welded to each other by the electron beam EB.

As mentioned above, together with the power generating element 10 formed with the positive foil laminated portion 11L and the negative foil laminated portion 12L, the positive collector main part 21, the positive collector auxiliary part 22, the negative collector main part 31, and the negative collector auxiliary part 32 are put on the XY table 51 movable in two-dimensional direction (X- and Y-directions).

On the other hand, an electron gun 50 is operated to continuously emit the electron beam EB in the traveling direction EBD. This electron gun 50 is disposed so that the traveling direction EBD of the electron beam EB is perpendicular to the X direction and the Y direction. Accordingly, the irradiation site irradiated by the electron beam EB can be moved by movement of this XY table 51.

The power generating element 10 and others are placed on the XY table 51 so that the positive collector main part 21 and the negative collector main part 31 are located on the side closest to the electron gun 50.

Firstly, the explanation is given to the welding of the contact portion 21A, the positive foil laminated portion 11L, and the auxiliary contact portion 22A. The electron beam EB is emitted from the electron gun 50 in the traveling direction EBD to irradiate the positive-side irradiation site L1 of the contact portion 21A, the positive foil laminated portion 11L, and the auxiliary contact portion 22A. At that time, the XY table 51 is driven in the X direction and the Y direction to move the contact portion 21A and others, thereby moving the positive-side irradiation site L1 irradiated by the electron beam EB.

In the first embodiment, the electron beam EB is emitted to travel in the traveling direction EBD from the contact portion 21A side to the positive foil laminated portion 11L side. In other words, the electron beam EB is emitted to impinge on the contact portion 21A earlier than the positive foil laminated portion 11L constituted of the long side portion 11a1 of the positive metal foil 11a. Thus, after the contact portion 21A is melted earlier and absorbs the energy of the electron beam EB which is then dispersed, the electron beam EB is allowed to indirectly irradiate the long side portion 11a1 of the positive metal foil 11a forming the positive foil laminated portion 11L in a thickness direction (the lamination direction DL) thereof. Furthermore, parts (one part and another part) of the positive metal foil 11a are in close contact with each other in the positive foil laminated portion 11L. Accordingly, the positive foil laminated portion 11L and the contact portion 21A of the positive collector main part 21 can be melted and appropriately welded to each other while restraining defects such as a missing part caused by sublimation (evaporation) of the positive metal foil 11a (the long side portion 11a1) in the positive foil laminated portion 11L.

The above welding step in which the electron beam EB is irradiated to the positive-side irradiation site L1 being moved can prevent the energy of the electron beam EB from concentrating on one point, at which the positive metal foil 11a, the contact portion 21A, and the auxiliary contact portion 22A may so rise in temperature as to sublimate or cause a blowhole resulting in a missing part.

In the first embodiment, furthermore, the contact portion 22A of the positive collector auxiliary part 22 is placed in contact with the positive foil laminated portion 11L at a leading side in the traveling direction EBD of the electron beam EB relative to the laminated portion 11L. Accordingly, even the contact portion 22A placed at the leading side in the traveling direction EBD of the electron beam EB relative to the positive foil laminated portion 11L can receive the energy of the electron beam EB. This makes it possible to prevent the energy of the electron beam EB from concentrating on a part of the positive metal foil 11a of the positive foil laminated portion 11L, located at the leading side in the traveling direction EBD of the electron beam EB, thereby preventing the occurrence of a missing part of the positive metal foil 11a. As above, the defects such as a missing part of the positive metal foil 11a can be restrained, and hence the secondary battery 1 can be manufactured in which the positive foil laminated portion 11L and the contact portion 22A of the positive collector auxiliary part 22 are reliably welded to each other. Consequently, the secondary battery 1 can be manufactured in which the positive foil laminated portion 11L is reliably welded to the contact portion 21A and the auxiliary contact portion 22A respectively.

In the first embodiment, the XY table 51 is moved to move the positive-side irradiation site L1 irradiated by the electron beam EB so that the positive-side welded region M1 becomes a nearly rectangular shape when viewed from the electron gun 50 side. In this embodiment, therefore, the position and the size (or area) of the positive-side welded region M1 can freely be designed with high degree of freedom of choice. Accordingly, the area of the positive-side welded region M1 can be determined appropriately and a secondary battery 1 with low connection resistance between the positive metal foil 11a and the positive collector member 20 can be manufactured.

The dimension (or thickness) of the contact portion 22A of the positive collector auxiliary part 22 in the traveling direction EBD of the electron beam EB is determined to be smaller than the dimension (or thickness) of the contact portion 21A of the positive collector terminal part 21 in the traveling direction EBD of the electron beam EB. As mentioned above, the contact portion 22A is disposed in order to prevent the occurrence of a missing part in the positive metal foil 11a (the long side portion 11a1) in the positive foil laminated portion 11L and hence does not have to be so thick. This configuration also applies to the contact portion 32A of the negative collector auxiliary part 32.

In the manufacturing method of the secondary battery 1 in the first embodiment, in the welding step, the electron beam EB is irradiated under vacuum. Accordingly, components in air are unlikely to enter the region M1 and oxidation less occurs. The secondary battery 1 can have the positive-side welded region M1 resistant to oxidation and with high quality.

The contact portion 31A, the negative foil laminated portion 12L, and the auxiliary contact portion 32A are welded to each other in the same manner as for the positive electrode side. Specifically, the electron beam EB is emitted from the electron beam 50 in the traveling direction EBD, while the XY table 51 is driven to move the contact portion 31A and others, thereby moving the negative-side irradiation site L2, which is irradiated sequentially by the electron beam EB.

In the first embodiment, the electron beam EB is emitted to travel in the traveling direction EBD from the contact portion 31A side to the negative foil laminated portion 12L side. Thus, the contact portion 21A is first melted earlier and absorbs the energy of the electron beam EB which is then dispersed, the electron beam EB is allowed to indirectly irradiate the long side portion 12a1 of the negative metal foil 12a forming the negative foil laminated portion 12L in a thickness direction (the lamination direction DL) thereof. Furthermore, parts of the negative metal foil 12a are in close contact with each other in the negative foil laminated portion 12L. Accordingly, the negative foil laminated portion 12L and the contact portion 31A of the negative collector main part 31 can be melted and appropriately welded to each other while restraining defects such as a missing part caused by sublimation (evaporation) of the negative metal foil 12a (the long side portion 12a1) in the negative foil laminated portion 12L.

The above welding step in which the electron beam EB is irradiated to the negative-side irradiation site L2 being moved can prevent the energy of the electron beam EB from concentrating on one point, at which the negative metal foil 12a, the contact portion 31A, and the auxiliary contact portion 32A may so rise in temperature as to sublimate or cause a blowhole resulting in a missing part.

In the first embodiment, furthermore, the contact portion 32A of the negative collector auxiliary part 32 is placed in contact with the negative foil laminated portion 12L at a leading side in the traveling direction EBD of the electron beam EB relative to the laminated portion 12L. Accordingly, even the contact portion 32A placed at the leading side in the traveling direction EBD of the electron beam EB relative to the positive foil laminated portion 12L can receive the energy of the electron beam EB. This makes it possible to prevent the energy of the electron beam EB from concentrating on a part of the negative metal foil 12a of the negative foil laminated portion 12L, located at the leading side in the traveling direction EBD of the electron beam EB, thereby preventing the occurrence of a missing part of the negative metal foil 12a. As above, the defects such as a missing part of the negative metal foil 12a can be restrained, and hence the secondary battery 1 can be manufactured in which the negative foil laminated portion 12L and the contact portion 32A of the negative collector auxiliary part 32 are reliably welded to each other. Consequently, the secondary battery 1 can be manufactured in which the negative foil laminated portion 12L is reliably welded to the contact portion 31A and the auxiliary contact portion 32A respectively.

In the first embodiment, the XY table 51 is moved to move the negative-side irradiation site L2 irradiated by the electron beam EB so that the negative-side welded region M2 becomes a nearly rectangular shape when viewed from the electron gun 50 side. In this embodiment, therefore, the position and the size (or area) of the negative-side welded region M2 can freely be designed with high degree of freedom of choice. Accordingly, the area of the negative-side welded region M2 can be determined appropriately and a secondary battery 1 with low connection resistance between the negative metal foil 12a and the negative collector member 30 can be manufactured.

In the manufacturing method of the secondary battery 1 in the first embodiment, in the welding step, the electron beam EB is irradiated under vacuum. Accordingly, components in air are unlikely to enter the negative-side welded region M2 and oxidation less occurs. The secondary battery 1 can have the negative-side welded region M2 resistant to oxidation and with high quality.

After the aforementioned connection process, the power generating element 10 is set in the battery case 41 by a well known technique. The positive terminal 21p of the positive collector main part 21 and the negative terminal 31p of the negative collector main part 31 are respectively placed through the cover 42 in a sealing relation with the cover 42. Furthermore, the cover 42 is bonded to the case body 41 to form the battery case 40. The electrolyte (not shown) is poured in the battery case 40 and then the safety valve 43 is attached to the cover 42. In the above way, the secondary battery 1 in the first embodiment is completed.

### MODIFIED EXAMPLE

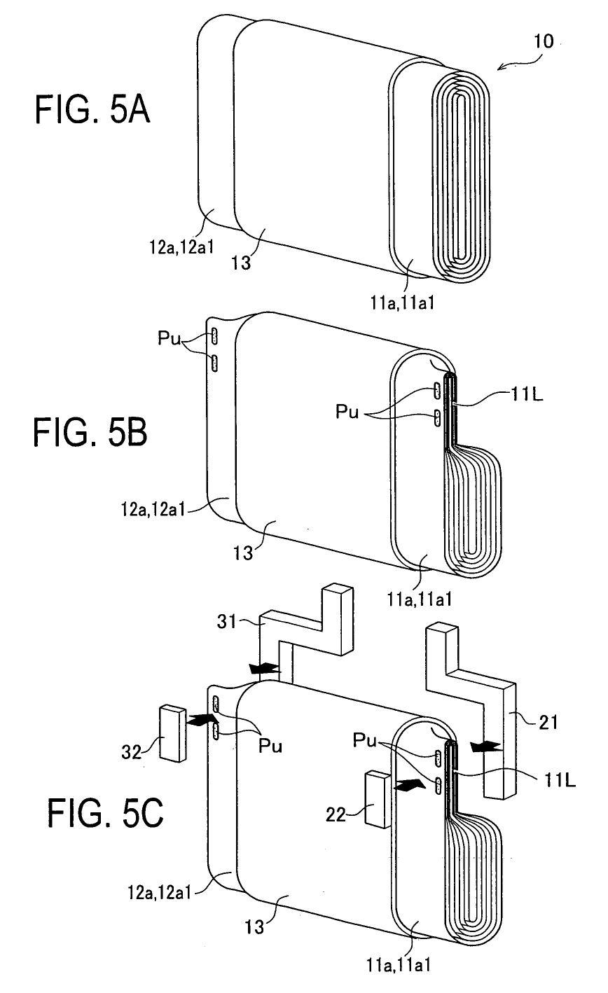

A modified example of the manufacturing method of the secondary battery 1 is explained below referring to FIGS. 5A to 5C.

This example is basically the same as the first embodiment excepting the addition of a foil contacting step prior to the contacting step.

The following explanation is therefore made with a focus on the differences from the first embodiment by assigning the same reference signs to similar or identical parts or components without repeating their details. Those similar or identical parts or components provide the same operations and advantages.

The manufacturing method of the secondary battery 1 in this modified example is explained referring to FIGS. 5A to 5C.

Firstly, the flat-shaped power generating element 10 is produced in the same way as in the first embodiment (see FIG. 5A). In this state, one part and another part of the long side portion 11a1 of the positive metal foil 11a are arranged in layers but spaced with clearances to be in noncontact with adjacent parts. The long side portion 12a1 of the negative metal foil 12a is also in a similar noncontact condition.

In this modified example, a foil contacting step is carried out prior to the contacting step. Specifically, parts of the long side portion 11a1 of the positive metal foil 11a are clamped and ultrasonic-welded by an ultrasonic welding machine not shown. The parts of the long side portion 11a1 of the positive metal foil 11a clamped in this way are made close contact (welded) with each other in ultrasonic welded regions Pu to form the positive foil laminated portion 11L in advance (see FIG. 5B). Similarly, parts of the long side portion 12a1 of the negative metal foil 12a are clamped and ultrasonic-welded by the ultrasonic welding machine to make one part and another part of the long side portion 12a1 of the negative metal foil 12a contact with each other in ultrasonic welded regions Pu to form the negative foil laminated portion 12L in advance.

Thereafter, in the contacting step, the positive foil laminated portion 11L is sandwiched in close contact between the contact portion 21A of the positive collector main part 21 and the contact portion 22A of the negative collector auxiliary part 22 by the vise or the like not shown. At that time, the contact portions 21A and 22A are arranged to cover the ultrasonic welded regions Pu (see FIG. 5C). As in the first embodiment, the positive foil laminated portion 11L is consequently in close contact with the contact portion 21A of the positive collector main part 21 on one side in the lamination direction DL and the contact portion 22A of the negative collector auxiliary part 22 on the other side, respectively (see FIG. 3C).

Similarly, the negative foil laminated portion 12L is sandwiched between the contact portion 31A of the negative collector main part 31 and the contact portion 32A of the negative collector auxiliary part 32 so that they are cover the ultrasonic welded regions Pu (see FIG. 5C). As in the first embodiment, therefore, the negative foil laminated portion 12L is also in close contact with the contact portion 31A of the negative collector main part 31 on one side in the lamination direction DL and the contact portion 32A of the negative collector auxiliary part 32 on the other side (see FIG. 5C).

Subsequently, as in the first embodiment, the welding step is performed to manufacture the secondary battery 1.

The manufacturing method of the secondary battery 1 in this modified example explained above includes the foil contacting step prior to the contacting step. In the foil contacting step, specifically, parts of the long side portion 11a1 of the metal foil 11a are placed in close contact with each others to form the foil laminated portion 11L in advance and parts of the long side portion 12a1 of the metal foil 12a are placed in close contact with each others to form the foil laminated portion 12L in advance, respectively. Thus, the subsequent contacting step can be started after the foil laminated portions 11L and 12L are completely made.

### Second Embodiment

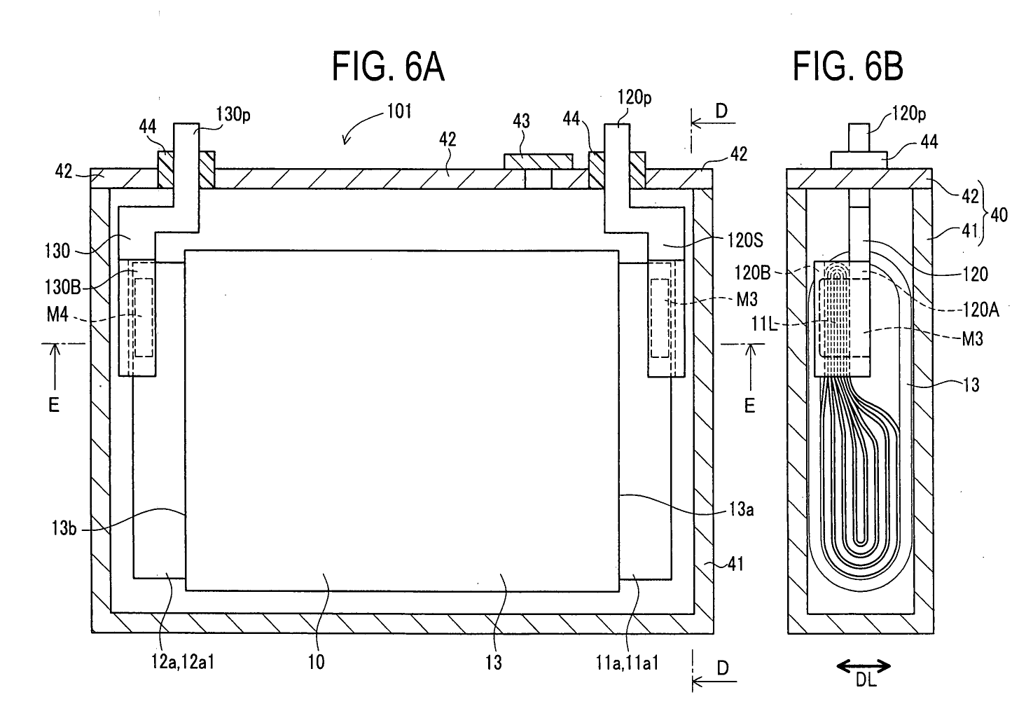

A secondary battery 101 in a second embodiment will be described below referring to FIGS. 6A to 9B.

The secondary battery 1 in the first embodiment was exemplified as a configuration that, in the collector members 20 and 30, the main parts 21 and 31 and the auxiliary parts 22 and 32 are arranged so that the respective contact portions 21A, 31A, 22A, and 32A are placed in close contact with both sides of either the foil laminated portion 11L or the foil laminated portion 12L in the lamination direction DL. The secondary battery 101 in the second embodiment is similar to the secondary battery 1 in the first embodiment except that each collector terminal member includes two contact portions which are placed in close contact with both sides of each foil laminated portion.

Accordingly, the following explanation is given with a focus on the differences from the first embodiment by assigning the same reference signs to similar or identical parts or components to those in the first embodiment without repeating their details. Those similar or identical parts or components provide the same operations and advantages.

The second battery 101 in the second embodiment is a lithium ion secondary battery including the power generating element 10, the battery case 40, a positive collector member 120, and a negative collector member 130.

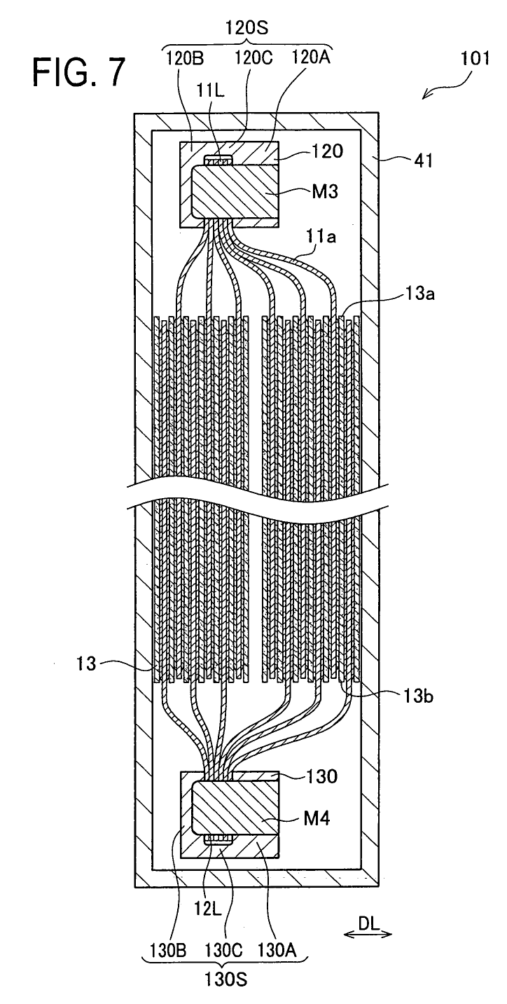

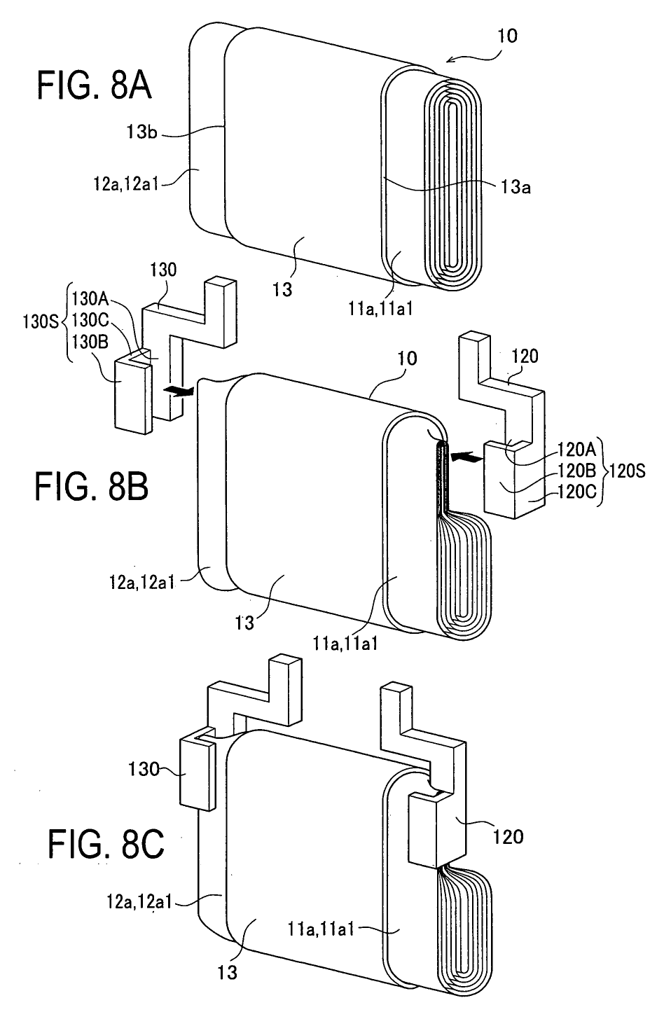

The positive collector member 120 made of metal includes a holding part 120S having an angular U-shape in cross section for holding the parts of the long side portion 11a1 of the positive metal foil 11a, in addition to a positive terminal 120p similar to the positive terminal 21p in the first embodiment. To be concrete, as shown in FIGS. 7 and 8B, the holding part 120S includes a plate-shaped first contact portion 120A continuous with the positive terminal 120p, a plate-shaped second contact portion 120B facing the first contact portion 120A, and a connecting portion 120C joining the first and second contact portions 120A and 120B. By a crimping technique mentioned later, this holding part 120S grips, or tightly holds, the positive foil laminated portion 11L of the positive metal foil 11a, in which one part and another part of the long side portion 11a1 extending from the first end face 13a of the separator 13 are laminated one on another, between the first and second contact portions 120A and 120B.

The negative collector member 130 is also made of metal as with the positive collector member 120 and includes a holding part 130S having an angular U-shape in cross section for holding the parts of the long side portion 12a1 of the negative metal foil 12a, in addition to a negative terminal 130p similar to the negative terminal 31p in the first embodiment. To be concrete, as shown in FIGS. 7 and 8B, the holding part 130S includes a plate-shaped first contact portion 130A continuous with the negative terminal 130p, a plate-shaped second contact portion 130B facing the first contact portion 130A, and a connecting portion 130C joining the first and second contact portions 130A and 130B. By a crimping technique mentioned later, this holding part 130S grips, or tightly holds, the negative foil laminated portion 12L of the negative metal foil 12a, in which one part and another part of the long side portion 12a1 extending from the second end face 13b of the separator 13 are laminated one on another, between the first and second contact portions 130A and 130B.

Furthermore, the positive foil laminated portion 11L is welded to the first and second contact portions 120A and 120B in a positive-side welded region M3 by an electron beam EB emitted to travel in a lamination direction DL of the positive foil laminated portion 11L in the same manner as in the first embodiment. Similarly, the negative foil laminated portion 12L is welded to the first and second contact portions 130A and 130B in a negative-side welded region M4 by an electron beam EB emitted to travel in the lamination direction DL.

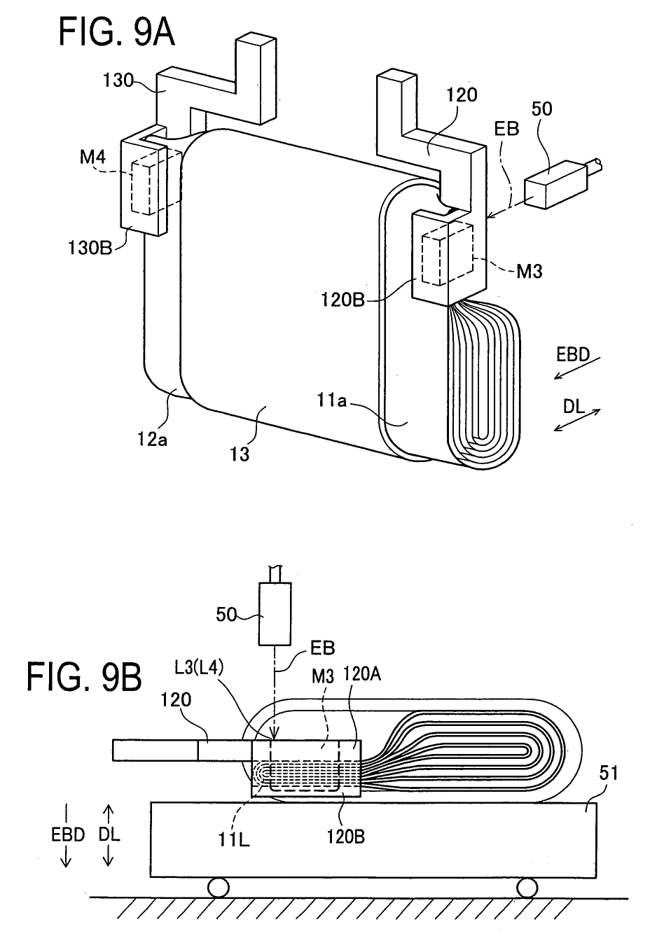

A manufacturing method of the secondary battery 101 in the second embodiment will be described below referring to FIGS. 8A to 8C and 9A and 9B.

The power generating element 10 formed in a flat shape as shown in FIG. 8A is first produced in such a way that the band-shaped positive electrode plate 11 and the negative electrode plate 12 are wound with the separator 13 interposed therebetween, as in the first embodiment.

In the contacting step, parts of the long side portion 11a1 of the positive metal foil 11a are tightly held by the holding part 120S of the positive collector member 120. To be specific, this holding part 120S is crimped to tightly hold about half (an upper half in FIG. 8B) of the long side portion 11a1 of the positive metal foil 11a between the first and second contact portions 120A and 120B. Accordingly, one part and another part of the long side portion 11a1 of the positive metal foil 11a are placed in close contact with each other to form the positive foil laminated portion 11L. Simultaneously, the positive foil laminated portion 11L is held in close contact with the first and second contact portions 120A and 120B respectively. In this way, the positive foil laminated portion 11L closely contacts with the first contact portion 120A of the positive collector member 120 on one side in the lamination direction DL and with the second contact portion 120B on the other side (see FIG. 8C).

In the second embodiment, the positive collector member 120 provided with the holding part 120S in which the first and second contact portions 120A and 120B are joined by the connecting portion 120C is used. The holding part 120S is crimped to tightly hold the positive foil laminated portion 11L between the first and second contact portions 120A and 120B. Therefore, in subsequent steps, the positive foil laminated portion 11L can be maintained in such form without using a vise or the like. Furthermore, the positive foil laminated portion 11L can be kept in close contact with the first and second contact portions 120A and 120B, so that the power generating element 10 and others are easy to handle.

In the contacting step in the second embodiment, similar to the first embodiment, one part and another part of the long side portion 11a1 are placed in close contact with each other to form the positive foil laminated portion 11L and also this foil laminated portion 11L is put in close contact with the first and second contact portions 120A and 120B respectively. Accordingly, the secondary battery 101 can be manufactured easily without the need for making the positive foil laminated portion 11L in advance.

Similarly, parts of the long side portion 12a1 of the negative metal foil 12a are tightly held by the holding part 130S of the negative collector member 130. Specifically, this holding part 130S is crimped to tightly hold about half (an upper half in FIG. 8B) of the long side portion 12a1 of the negative metal foil 12a between the first and second contact portions 130A and 130B. Accordingly, one part and another part of the long side portion 12a1 are placed in close contact with each other to form the negative foil laminated portion 12L. Simultaneously, the negative foil laminated portion 12L is held in close contact with the first contact portion 130A of the negative collector member 130 on one side in the lamination direction DL and with the second contact portion 130B on the other side (see FIG. 8C).

Also for the negative electrode side, the negative collector member 130 provided with the holding part 130S in which the first and second contact portions 130A and 130B are joined by the connecting portion 130C is used. The holding part 130S is crimped to tightly hold the negative foil laminated portion 12L between the first and second contact portions 130A and 130B. Therefore, in subsequent steps, the negative foil laminated portion 12L can be maintained in such form without using a vise or the like. Furthermore, the negative foil laminated portion 12L can be kept in close contact with the first and second contact portions 130A and 130B, so that the power generating element 10 and others are easy to handle.

Furthermore, the negative foil laminated portion 12L is formed and simultaneously held in close contact with the first and second contact portions 130A and 130B. This makes it easier to manufacture the secondary battery 101 as compared with the case where the negative foil laminated portion 12L is formed in advance.

A welding step is explained below referring to FIGS. 9A and 9B. In the first embodiment, in the welding step, the positive foil laminated portion 11L is welded to the contact portion 21A and the auxiliary contact portion 22A in the positive-side welded region M1 and the negative foil laminated portion 12L is welded to the contact portion 31A and the auxiliary contact portion 32A in the negative-side welded portion M2.

On the other hand, the second embodiment is different from the first embodiment in that the positive foil laminated portion 11L is welded to the first and second contact portions 120A and 120B in the positive-side welded region M3 and the negative foil laminated portion 12L is welded to the first and second contact portions 130A and 130B in the negative-side welded region M4. Since only those configurations are different from those in the first embodiment, the details of the welding step are not repeated herein.

Also in the second embodiment, the electron beam EB is emitted to travel in an appropriate traveling direction EBD so as to impinge on the first contact portion 120A earlier than the positive foil laminated portion 11L. At that time, parts of the positive metal foil 11a closely contact with each other in the positive foil laminated portion 11L. It is therefore possible to melt and appropriately weld the positive foil laminated portion 11L and the first contact portion 120A to each other while restraining defects such as a missing part caused by sublimation (evaporation) of the positive metal foil 11a (the long side portion 11a1) in the positive foil laminated portion 11L.

The second contact portion 120B is placed at the leading side in the traveling direction EBD relative to the positive foil laminated portion 11L and in contact therewith. This makes it possible to prevent the occurrence of a missing part in the positive metal foil 11a of the positive foil laminated portion 11L, located at the leading side in the traveling direction EBD of the electron beam EB, and to reliably weld the positive foil laminated portion 11L and the second contact portion 120B.

In the above way, the secondary battery 101 can be manufactured, in which the positive foil laminated portion 11L is reliably welded to the first and second contact portions 120A and 120B respectively.

In addition, the electron beam EB is irradiated for welding while a positive-side irradiation site L3 is moved, thereby preventing the energy of the electron beam EB from concentrating on one point, at which the positive metal foil 11a, the first contact portion 120A, and the second contact portion 120B may so rise in temperature as to sublimate or cause a blowhole resulting in a missing part.

In the second embodiment, as in the first embodiment, the XY table 51 is moved to move the positive-side irradiation site L3 irradiated by the electron beam EB so that the positive-side welded region M3 becomes a nearly rectangular shape when viewed from the electron gun 50 side. In this embodiment, therefore, the position and the size (or area) of the positive-side welded region M3 can freely be designed with high degree of freedom of choice. Accordingly, the area of the positive-side welded region M3 can be set appropriately and the secondary battery 101 with low connection resistance between the positive metal foil 11a and the positive collector member 120 can be manufactured.

The dimension (or thickness) of the second contact portion 120B in the traveling direction EBD of the electron beam EB is determined to be smaller than the dimension (thickness) of the first contact portion 120A in the traveling direction EBD of the electron beam EB. This is to prevent the occurrence of a missing part in the positive metal foil 11a of the positive foil laminated portion 11L and hence the second contact portion 120B does not have to be so thick.

The above configuration also applies to the welding step for the negative foil laminated portion 12L and the first and second contact portions 130A and 130B, and to the negative-side welded region M4. Thus, the details thereof are not repeated herein.

After the aforementioned connection process, as in the first embodiment, the power generating element 10 is set in the battery case 41. The positive terminal 120p of the positive collector member 120 and the negative terminal 130p of the negative collector member 130 are respectively placed through the cover 42 in a sealing relation with the cover 42. Furthermore, the cover 42 is bonded to the case body 41 to form the battery case 40. The electrolyte (not shown) is poured in the battery case 40 and then the safety valve 43 is attached to the cover 42. In the above way, the secondary battery 101 in the second embodiment is completed.

### Third Embodiment

A secondary battery 201 in a third embodiment will be described below referring to FIGS. 2A, 2B, and 10A, 10B, 11A to 11C, 12A, and 12B.

The secondary battery in the third embodiment is identical to that in the first embodiment except that the collector main part and the collector auxiliary part include a plurality of protrusions, respectively, in corresponding positions.

Accordingly, the following explanation is given with a focus on the differences from the first embodiment by assigning the same reference signs to similar or identical parts or components to those in the first embodiment without repeating their details. Those similar or identical parts or components provide the same operations and advantages.

A positive electrode collector member (hereinafter, a “positive collector member”) 220 in the third embodiment constituted of two components; a positive electrode collector terminal main part (hereinafter, “positive collector main part” or “main part”) 221 and a positive electrode collector terminal auxiliary part (hereinafter, “positive collector auxiliary part” or “auxiliary part”) 222. A negative electrode collector member (hereinafter, a “negative collector member”) 230 is also constituted of two components; a negative electrode collector terminal main part (hereinafter, “negative collector main part” or “main part”) 231 and a negative electrode collector terminal auxiliary part (hereinafter, “negative collector auxiliary part” of “auxiliary part”) 232.

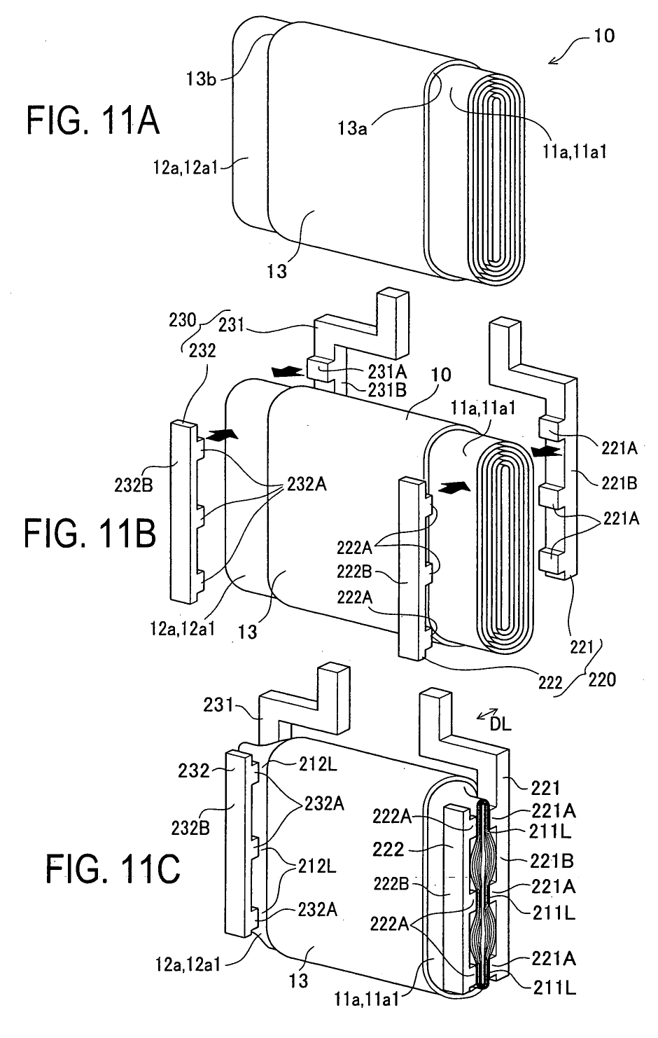

Each of the main parts 221 and 231 is made of a plate bent in crank form including a terminal 221p or 231p at one end as with the main parts 21 and 31 in the first embodiment. Unlike the first embodiment, body portions 221B and 231B of the main parts 221 and 231 are formed with a plurality of (three in this embodiment) contact portions 221A and 231A protruding in rectangular form from the body portions 221B and 231B, respectively (see FIG. 11B). The collector auxiliary parts 222 and 232 are also formed with a plurality of (three in this embodiment) contact portions 222A and 232A protruding in rectangular form from body portions 222B and 232B each having a rectangular plate shape (see FIG. 11B). Those contact portions 222A of the auxiliary part 221 and the contact portions 232A of the auxiliary part 232 are arranged in corresponding to the contact portions 221A of the main part 221 and the contact portions 231A of the main part 231, respectively. Accordingly, each of the collector members 220 and 230 is placed in close contact with the metal foils 11a and 12a (the long side portions 11a1 and 12a1) mentioned later, respectively, in several portions. This makes it possible to provide more than one current collecting path whereby current collection can be performed with lower resistance as compared with the case where each of the collector members is placed in close contact with the metal foils in a single portion.

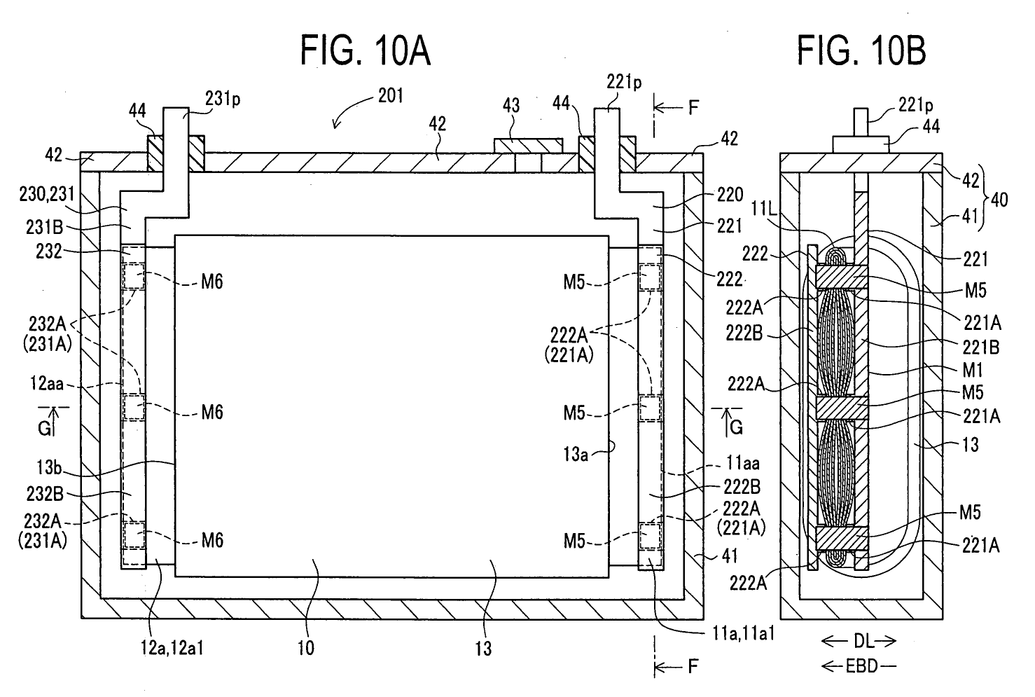

In the secondary battery 201 in the third embodiment, parts of the long side portion 11a1 of the positive metal foil 11a extending from the separator 13 are sandwiched between the contact portions 221A and the auxiliary contact portions 222A so that one part and another part of the long side portion 11a1 are laminated in close contact with each other to form a positive foil laminated portions 211L. Furthermore, a part of each positive foil laminated portion 211L, a part of each contact portion 221A, and a part of each auxiliary contact portion 222A are welded to each other by the electron beam EB to form a positive-side welded region M5 (see FIG. 10B).

The portions of the long side portion Hal of the positive metal foil 11a extending from the separator 13, excepting the positive foil laminated portions 211L, are arranged with clearances therebetween in nonocontact relation. Accordingly, the electrolyte not shown is allowed to be distributed through the clearances to every portion inside the power generating element 10 as in the first embodiment. Gas generated inside the power generating element 10 during charge and discharge of the secondary battery 201 will be released out of the power generating element 10 through the clearances, but within the battery case 40.

As for the negative metal foil 12a, similar to the positive metal foil 11a, parts of the long side portion 12a1 extending from the separator 13 are sandwiched between the contact portion 231A and the auxiliary contact portion 232A so that one part and another part of the long side portion 12a1 are laminated in close contact with each other to form a negative foil laminated portion 212L. A part of each negative foil laminated portion 212L, a part of the contact portion 231A, and a part of the auxiliary contact portion 232A are welded by the electron beam EB to from a negative-side welded region M6 (see FIG. 10B).

The portions of the long side portion 12a1 of the negative metal foil 12a extending from the separator 13, excepting the negative foil laminated portions 212L, are arranged with clearances therebetween in noncontact relation. Accordingly, the electrolyte not shown is allowed to be distributed through the clearances to every portion inside the power generating element 10 as in the first embodiment. Furthermore, gas generated inside the power generating element 10 during charge and discharge of the secondary battery 201 will be released out of the power generating element 10 through the clearances, but within the battery case 40.

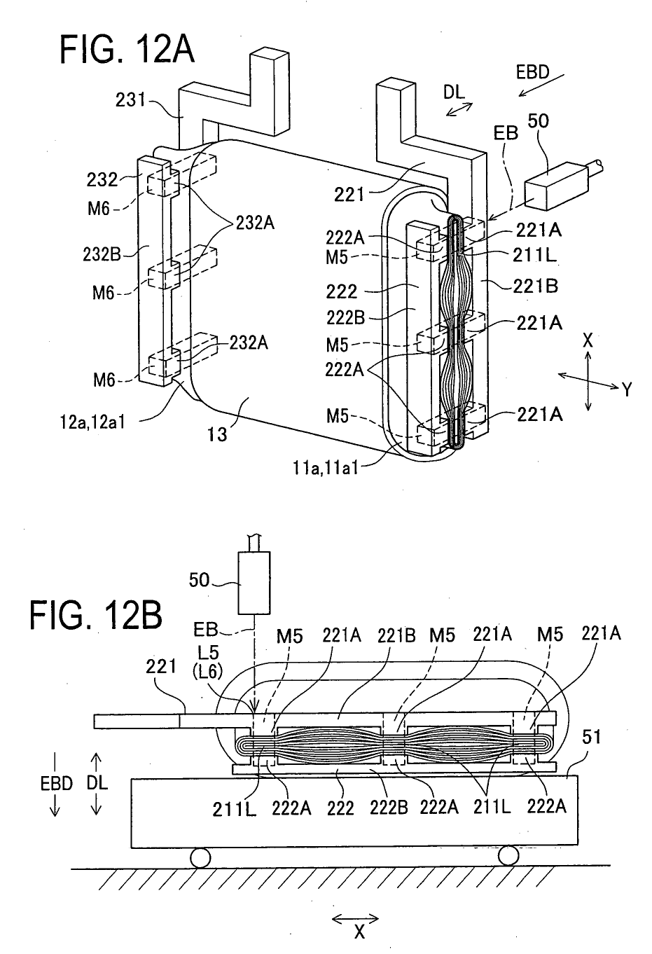

A manufacturing method of the secondary battery 201 in the third embodiment will be described below referring to FIGS. 11A to 11C and 12A and 12B.

In the third embodiment, the flat-shaped power generating element 10 is formed (see FIG. 11A) in the same way as in the first embodiment. In this state, parts of the long side portion 11a1 of the positive metal foil 11a are arranged in layer but in noncontact relation to adjacent ones. The long side portion 12a1 of the negative metal foil 12a is also in a similar noncontact condition.

In the contacting step, parts of the long side portion 11a1 of the positive metal foil 11a are sandwiched between the contact portion 221A of the positive collector main part 221 and the contact portion 222A of the positive collector auxiliary part 222 (see FIG. 11B). Specifically, the long side portion 11a1 of the positive metal foil 11a extending from the first end face 13a of the separator 13 is sandwiched between the contact portions 221A and 222A by use of a vise or the like. Thus, one part and another part of the long side portion 11a of the positive metal foil 11a are placed in close contact with each other to form three positive foil laminated portions 211L. Each foil laminated portion 211L closely contacts with the contact portion 221A on one side and with the contact portion 222A on the other side respectively (see FIG. 11C).

In a similar fashion, parts of the long side portion 12a1 of the negative metal foil 12a are sandwiched between the contact portion 231A of the negative collector main part 231 and the contact portion 232A of the negative collector auxiliary part 232 (see FIG. 11B). Accordingly, one part and another part of the long side portion 12a1 of the negative metal foil 12a are placed in close contact to form three negative foil laminated portions 212L. Each laminated portion 212L closely contacts with the contact portion 231A on one side and with the contact portion 232A on the other side respectively (see Fig. 11C).

A welding step is explained below referring to FIGS. 12A and 12B. In third embodiment, as in the above embodiments, each positive foil laminated portion 211L is welded to the contact portions 221A and 222A by the electron beam EB. Similarly, each negative foil laminated portion 212L is welded to the contact portions 231A and 232A by the electro beam EB.

Specifically, the electron gun 50 is operated to emit the electron beam EB in the traveling direction EBD to irradiate a positive-side irradiation site L5 of the contact portion 221A, the positive foil laminated portion 211L, and the auxiliary contact portion 222A. At that time, the XY table 51 on which the power generating element 10 and others are set is moved in an X direction and a Y direction to move the irradiation site L5 while the electron beam EB is sequentially irradiated.

The contact portion 231A, the negative foil laminated portion 212L, and the auxiliary contact portion 232A are welded in the same manner as the above manner for the positive electrode side. Concretely, the electron gun 50 is operated to emit the electron beam EB in the traveling direction EBD while the XY table 51 is driven to move the contact portion 231A and others, thereby moving a negative-side irradiation site L6, which is irradiated sequentially by the electron beam EB.

The present invention is explained as above in the first, second, and third embodiments and the modified example, but the present invention is not limited to the above description and may be embodied in other specific forms without departing from the essential characteristics thereof.

The secondary battery in each of the above embodiments is a lithium ion secondary battery but may be any secondary battery; for example, a nickel-metal hydride secondary battery, a nickel-cadmium secondary battery, and others. In each of the above embodiments, the winding type power generating element is employed. Each foil laminated portion is made by laminating one part and another part of the metal foil (the long side portion) into close contact relation. Alternatively, a lamination-type power generating element may be adopted in which a plurality of positive electrode plates and a plurality of negative electrode plates are laminated alternately with separators being interposed therebetween. In this case, for example, the positive foil laminated portion is made by lamination of positive metal foils and the negative foil laminated portion is made by lamination of negative metal foils.

The above embodiments show that the two contact portions 21A and 22A or 31A and 32A are disposed in close contact relation on both sides of the foil laminated portion 11L or 12L in the lamination direction DL and those three components are welded to each other. As an alternative, the contact portions may be placed on only one side of the foil laminated portion 11L or 12L (closer to the electron gun 50, i.e., at the rear side in the lamination direction EBD of the electron beam EB) relative to the foil laminated portion 11L or 12L so that two components are welded to each other.

In each of the above embodiments, the XY table 51 is used to move the irradiation site L1 and others irradiated by the electron beam EB. An alternative is to operate the electron gun to deflect the electron beam EB to move the position of an irradiation spot within a predetermined region to be irradiated. Another alternative is to combine the movement of the table and the deflection of the electron beam.

In the third embodiment, the contact portions 221A and 231A and the auxiliary contact portions 222A and 232A are respectively provided in three places, but not limited to three.

In the above embodiments, an energy beam for welding is the electron beam, but it may be a laser beam, for example.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A secondary battery comprising:
a power generating element having a positive electrode plate, including a positive metal foil and a negative electrode plate including a negative metal foil; and
at least one of a positive electrode collector terminal member welded to the positive metal foil and a negative electrode collector terminal member welded to the negative metal foil,
wherein one of the positive metal foil and the negative metal foil includes a foil laminated portion in which the metal foils are laminated in close contact with each other or a foil laminated portion in which one part and another part of the metal foil are laminated in close contact with each other,
one of the positive electrode collector terminal member and the negative electrode collector terminal member includes a contact portion placed on at least one side of the foil laminated portion in a lamination direction thereof and in close contact with the foil laminated portion,
one of a welded region between the positive metal foil and the positive electrode collector terminal member and a welded region between the negative metal foil and the negative electrode collector terminal member is formed in such a way that the metal foils or the parts of the metal foil in the foil laminated portion are irradiated and welded to each other and the foil laminated portion and the contact portion are irradiated and welded to each other by an energy beam emitted to travel in the lamination direction from a contact portion side toward a foil laminated portion side while an irradiation site is moved.

2. The secondary battery according claim 1, wherein the welded region is formed by irradiation of an electron beam used as the energy beam.

3. The secondary battery according claim 2, wherein the secondary battery is a nonaqueous electrolyte, lithium ion secondary battery.

4. The secondary battery according claim 1, wherein the collector terminal member includes the contact portions placed on both sides of the foil laminated portion in the lamination direction.

5. A manufacturing method of a secondary battery comprising a power generating element having a positive electrode plate including a positive metal foil and a negative electrode plate including a negative metal foil; and at least one of a positive electrode collector terminal member welded to the positive metal foil and a negative electrode collector terminal member welded to the negative metal foil,
the method comprising:
a contacting step in which a contact portion of one of the positive electrode collector terminal member and the negative electrode collector terminal member is placed in close contact with at least one side of the foil laminated portion in a lamination direction thereof, the foil laminated portion including one of the positive metal foils and the negative metal foils or one of parts of the positive metal foil and parts of the negative metal foil, which are laminated in close contact with each other, and
a welding step in which an energy beam is emitted to travel in the lamination direction from a contact portion side to a foil laminated portion side to irradiate the contact portion and the foil laminated portion while an irradiation site is moved, to weld the metal foils or the parts of the metal foil in the foil laminated portion to each other and weld the foil laminated portion to the contact portion.

6. The manufacturing method of secondary battery according claim 5, wherein the energy beam is an electron beam.

7. The manufacturing method of secondary battery according claim 6, wherein the secondary battery is a nonaqueous electrolyte, lithium ion secondary battery.

8. The manufacturing method of secondary battery according claim 5, wherein the contacting step includes placing the foil laminated portion and the contact portion in close contact relation and laminating the metal foils or one part and another part of the metal foil of the power generating element into close contact relation to form the foil laminated portion.

9. The manufacturing method of secondary battery according claim 5, further comprising a foil contacting step in which the metal foils or one part and another part of the metal foil of the power generating element are laminated in close contact with each other to form the foil laminated portion,
the foil contacting step being performed prior to the contacting step.

10. The manufacturing method of secondary battery according claim 5, wherein the contacting step includes placing the contact portion of the collector terminal member in close contact with both sides of the foil laminated portion in the lamination direction.

11. The manufacturing method of secondary battery according claim 10, wherein the collector terminal member includes:
a first contact portion placed on one side of the foil laminated portion in the lamination direction; and
a second contact portion placed on the other side in the lamination direction.

12. The manufacturing method of secondary battery according claim 11, wherein the contacting step includes deforming the collector terminal member to tightly hold the foil laminated portion in close contact with and between the first and second contact portions.
